(19) United States
(12) Patent Application Publication
(10) Pub. No.: US 2011/0104345 A1
(43) Pub. Date: May 5, 2011

(54) METHOD OF REDUCING ACRYLAMIDE BY TREATING A FOOD INGREDIENT

(75) Inventors: Ajay Rajeshwar BHASKAR, Allen, TX (US); Amanda GRZEDA, Allen, TX (US); Jennifer Bell RAYMOND, Plano, TX (US); Michael Grant TOPOR, Little Elm, TX (US); Thomas Anthony TREZZA, Plano, TX (US)

(73) Assignee: FRITO-LAY NORTH AMERICA, INC., Plano, TX (US)

(21) Appl. No.: 12/887,301

(22) Filed: Sep. 21, 2010

Related U.S. Application Data
(63) Continuation-in-part of application No. 11/942,924, filed on Nov. 20, 2007, now Pat. No. 7,820,223.
Application No. 11/942,924 is a continuation-in-part of application No. 12/189,404, filed on Aug. 11, 2008.

(51) Int. Cl. A23L 1/216; A23B 7/153

(52) U.S. Cl. 426/262; 426/637

(57) ABSTRACT

Disclosed is a method for making low acrylamide food ingredients. When the treated food ingredient powders or flakes made by the present invention are used to make a low moisture, shelf stable food product, the level of acrylamide will be lower than if untreated food ingredient powders or flakes are used. The present invention is directed towards making dehydrated food ingredients from raw foods having relatively high levels of reducing sugars by making a dryable puree. Optionally an acrylamide reducing agent can be added to the puree before drum drying and grinding the dried puree into a powder.

### CROSS-REFERENCE TO RELATED APPLICATIONS

This application is a continuation-in-part of co-pending U.S. patent application Ser. No. 11/942,924, filed Nov. 20, 2007, and co-pending U.S. patent application Ser. No. 12/189,404, filed Aug. 11, 2008, the technical disclosures of which are hereby incorporated by reference.

### BACKGROUND OF THE INVENTION

1. Technical Field

The present invention, in one embodiment, relates to a method for producing dehydrated food ingredients, and more specifically to a method for making dehydrated food ingredients that can be used to make fabricated low moisture shelf-stable ready to eat food products having a reduced level of acrylamide.

2. Description of Related Art

In the food industry, potato-based products are typically made from dough mixes incorporating potato derivatives such as potato flakes, potato granules, potato flour, and potato starch. Examples of such potato-based products include potato chips and potato sticks.

Potato flakes and potato granules are the most common types of dehydrated potato products. Potato flakes and potato granules comprise dehydrated single cells, or aggregates of cells, of the potato tuber dried to a moisture content of 6% to 8%. As the names imply, potato flakes have a crystal-like shape, while potato granules have a granular shape. Both potato flakes and potato granules can be rehydrated (i.e., reconstituted) to make mashed potato products and fabricated snack products.

Various processes for making potato flakes and potato granules are well known in the art. An object of most prior art processes is to provide flakes or granules that can be rehydrated to make a potato product that has the flavor and texture of fresh cooked potatoes.

FIG. 1 illustrates process steps in a conventional prior art process for making potato flakes. Initially, fresh potatoes are washed, peeled, sliced into slices of about 0.5 inches and optionally rinsed. The raw potato slices are then precooked, typically by immersion in water held at about 160° F. to 165° F. (71.1° C. to 73.9° C.) for a period of about 15 to 20 minutes. As used herein, the terms “precooked” and “blanched” are synonymous. The pH of the water in the precooking step is typically 6.25 to 6.50. The precooking step gelatinizes starches within the potato cells, preferably with minimal swelling and bursting of the potato cells, such that retrogradation can take place during a subsequent cooling step. The bonds formed between the potato cells will thus be preserved during subsequent cooking and drying steps, and the reconstituted finished flake will have a reduced stickiness.

The cooling step is performed by immersing the precooked potato slices in water held at, or below, 75° F. (23.9° C.) for about 20 to 60 minutes. Following cooling, the potato slices are cooked, typically with steam, at a temperature of about 190° F. to 250° F. (87.8° C. to 121° C.) for 15 to 60 minutes. One type of steam cooker includes a screw conveyor which moves the potato slices through a steam chamber containing live steam.

Following cooking, the cooked potato slices are comminuted to form a potato mash. Typical means for comminuting potato slices include ricing, mashing, and shredding. Next, additives are added to the potato mash to enhance flavor, texture, stability, and mash drying. Representative additives include solutions of sodium bisulfite for retarding non-enzymatic browning, and emulsions of a monoglyceride emulsifier, antioxidants and various chelating agents. Following the additive step, a drying step is performed on the potato mash, typically with a drum dryer. The drum dryer dries the mash into a potato sheet having a moisture content of about 6% to 10%. Following drying, the potato sheet can be comminuted into potato flakes using a comminuting apparatus such as a hammermill.

FIG. 2 illustrates process steps in a conventional prior art process for making potato granules. Initially raw potatoes are washed, peeled, sliced, precooked, cooled, cooked, comminuted and additives added substantially as previously described. During a mash mixing step, hot cooked potatoes are mixed with dry add-back granules until a homogeneous moist mix is obtained. Following mash mixing, a conditioning step equalizes the moisture throughout the mix, which is then passed over a fine mesh vibrating screen to remove large agglomerates and bruised portions of potato tissues. The product is then further mixed, and dried using a drying apparatus such as an air lift dryer, or a fluidized bed dryer. Following drying to a moisture content of about 12% to 13%, a portion of the material is removed for add back, and the remainder is then finish dried to a moisture content of about 6% to 10%, again by using a drying apparatus.

Both of the above-described processes for making potato flakes and potato granules have been used in the art since about the 1950s. Over the years various processes have been proposed in which the above fabrication processes are modified. Representative processes are described in U.S. Pat. Nos. 5,707,671 and 5,292,542 to Beck et al.; U.S. Pat. No. 3,574,643 to Lewis; and U.S. Pat. No. 3,764,716 to Rainwater et al.

Potato flakes are used as ingredients in many food products including fabricated snack chips. While the specific chemical composition of the potato flakes or potato granules is based upon several factors such as potato variety, type of soil and geographic location in which the potato is grown, and storage environment, most potatoes naturally have the amino acid asparagine and native reducing sugars such as fructose and glucose that can form acrylamide when subjected to sufficient heat. There is little acrylamide formation in potato flakes possibly because potato flakes and granules typically have moisture contents of between about 6% and about 15% by weight. For example, analysis of flakes has revealed very low acrylamide levels in flakes (less than 100 ppb). However, when these flakes are used in doughs which are subsequently thermally processed at temperatures above 120° C. to make low moisture food products (e.g., moisture contents less than 3% by weight), such food products can have levels of acrylamide higher than 100 ppb. Consequently, it would be desirable to make a food ingredient, such as a flake, granule, or powder that could be used as an ingredient in a food product which results in a food product having a reduced level of acrylamide. It would also be desirable to provide an effective treatment method for lowering the level of acrylamide in a food product made from a sliced, shredded, or pureed vegetable.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 depicts a flow diagram of process steps in a prior art process for making potato flakes;

FIG. 2 depicts a flow diagram of process steps in a prior art process for making potato granules;

FIG. 3 depicts a flow diagram of a method for making a treated dehydrated food ingredient in accordance with one embodiment of the present invention;

FIG. 4 depicts a flow diagram of a method for making treated food ingredients in accordance with one embodiment of the present invention; and

FIG. 5 depicts a flow diagram of a method for making treated food ingredients in accordance with one embodiment of the present invention.

### DETAILED DESCRIPTION

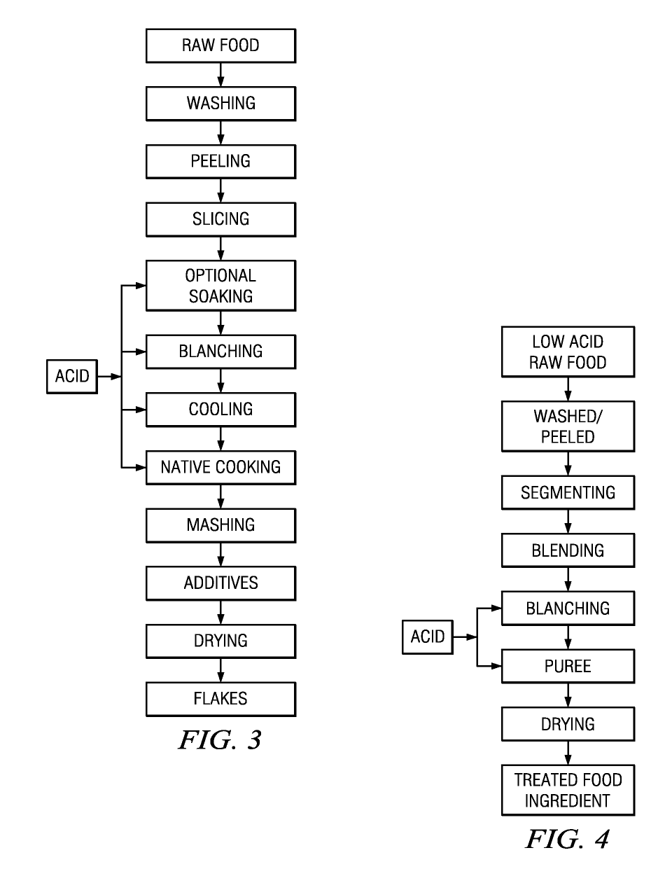

FIG. 3 depicts a flow diagram of a method for making a treated dehydrated food ingredient in accordance with one embodiment of the present invention. FIG. 3 shows only one embodiment of the current invention. Various steps and ingredients may be inserted or removed from the illustrated embodiment and still be within the scope of the present invention.

First, one or more raw food substrates having the same or different compositions, such as potatoes, can be selected and optionally blended together to reach a desired composition. For example, potatoes having a relatively low reducing sugar content, e.g., 0.8% by weight, can be mixed with potatoes having a higher reducing sugar content, e.g., 2% by weight, to achieve the level of reducing sugars desired in the potato mash. The specific chemical composition, including the reducing sugar concentration, of a potato is based upon several factors such as potato variety, type of soil and geographic location in which the potato is grown, and storage environment. Consequently, it may be desirable to blend raw potato stock to create a potato mash having a desired chemical composition profile. Any commercially available potatoes used to prepare conventional potato flakes can be used. For example, potatoes of the chipping variety that can be used include, but are not limited to, Aurora, Agria, Atlantic, Erntestolz, Idaho Russet, Kinnebec, Kennebec, Lady Rosetta, Lady Clair, Hermes, Maris Piper, Mentor, Monona, Norgold, Norchip, Norkota, Oneida, Sebago, Saturna, Snowden, and Tobique.

Non-chipping potato varieties can also be used, including, but not limited to, Marfona, King Edward, Yukon Gold, Desiree, Karlena and Estima. Similarly, French fry varieties such as Russet Burbank, and Bintje can be used. While chipping potatoes typically used for making potato crisps have relatively low levels of reducing sugars, and are not typically used to make French fries or baked potatoes, any potato can be used in accordance with the present invention, and the present invention is not limited by physiological or biological make up of the potato.

The blended or unblended potatoes can then be washed by methods well known in the art. Next, the potatoes are preferably peeled such that at least about 80% of the peel is removed and more preferably at least about 85% of the peel is removed and even more preferably between about 85% and about 95% of the peel is removed and in one embodiment up to about 100% of the peel is removed. Because potatoes are often oval and because outer peripheral potato surfaces often comprise concave sections, especially in areas of the eye of the potato, increasing the peel removal level above 88% and especially above 95% can result in changing the shape of the peeled potato from oval to round and can result in substantially higher levels of pulp loss. Flakes made from a fully peeled potato will result in a lower level of acrylamide when used as an ingredient in thermally processed foods than flakes made from potatoes made with no or partial peeling.

The washed and peeled potatoes can then be segmented into a smaller size. Segmenting can comprise slicing, dicing, ricing, cubing, etc. Virtually any method which reduces the size of the potatoes can be used in the segmenting step. In one embodiment, the potatoes which are segmented into potato slices are preferably cut to a thickness of between about 0.1 inches and about 0.5 inches and more preferably between about 0.3125 inches to about 0.50 inches. Applicants have found that flakes made from these slice thicknesses will result in a lower level of acrylamide when used as an ingredient in thermally processed foods than flakes made from potatoes made with thicker slices. It is believed that such result is because of the increased surface area to volume ratio that provides additional exposure to the acid blanching step described below. The surface area to volume ratio can also be raised by further dicing the slices, e.g., by cutting a sliced slab into smaller sized pieces having the same thickness as the sliced slab, and/or by cutting the slab into a ridged configuration. It should be pointed out that thinner slices (e.g., 0.053 inches) than disclosed above can be used; however, slicing thinner can result in undesirable losses of potato matter.

Next, in one embodiment, the sliced food pieces, also known as slabs, are treated in an acidic solution after the slicing step and prior to the mashing step to make a plurality of treated food pieces. As used herein, a “treated food piece” refers to a food that has been contacted in an acidic solution having a pH of between about 3.0 and about 6.0 and in one embodiment between about 3.5 and about 5.0 during a soaking step, a blanching step, washing step, and/or a cooling step prior to a native moisture cooking step (typically a steam cooking step), and/or the native cooking step, as shown in FIG. 3, or if no native cooking step is used, then prior to any drying step shown in FIG. 4. As used herein, “a native moisture cooking step” refers to a cooking step whereby a food is cooked, but retains a moisture content within about 5% of its native moisture content after the native moisture cooking step and prior to the mashing step. Thus, the dehydration from the native moisture cooking step is minimal to non-existent. In one embodiment, one or more acrylamide reducing agents discussed below can be used in combination with the acid solution.

An acidic solution having a pH above about 6.0 does not effectively treat the slab. A pH lower than about 3.5 can damage the cell walls causing the surface of the potato slice to peel off making it difficult to native moisture cook the slice. In one embodiment, the pH is measured at or near the outlet of the unit operation. For example, the pH of the blancher is measured near or at the outlet of the blancher.

In one embodiment, the acidic treatment solution comprises a temperature of between about 70° F. and about 212° F., more preferably between about 150° F. and about 180° F. and most preferably between about 160° F. and about 175° F. Higher temperatures require less acid (e.g., the pH range closer to 5.0 can be used) to achieve the same desired results. In one embodiment, the slices are soaked between about 15 minutes and about 30 minutes. While such a range is preferable because it is a typical time spent in the blancher in an existing flake manufacturing operation, other suitable times can be used depending upon the specific food substrate. In an acid blanching embodiment, sufficient acid is injected to maintain a pH of between about 3.5 and about 6.0 throughout the blancher. A blancher can have a recycle pump to recycle water from the downstream end of the blancher back to the upstream end of the blancher. Because it may be desirable to wash away free starch in the blancher, additional make-up water may be necessary and a continuous make-up acid injection system can be used whereby the acid level at or near the outlet of the blancher can be measured and acid can be added as necessary to ensure the blanch water in the blancher maintains the desired pH range.

In one embodiment, the acid used can be selected from acids recognized both as food grade and Generally Recognized as Safe (GRAS) by the Food Chemical News Guide. It should be pointed out that food grade acids can be a strong acid, a weak acid, an organic acid, or mixtures thereof. Examples of food grade acids include, but are not limited to, one or more acids selected from citric acid, phosphoric acid, and hydrochloric acid.

In one embodiment, the blanched food pieces are then cooled by immersing the precooked/blanched food slices in water held at, or below, 75° F. (23.9° C.) for about 20 minutes to 60 minutes. In an alternative embodiment, if a dough with more cohesion will be made from the food pieces, the cooling step can be omitted and slices can be rinsed with hot water (e.g, >120° F. to 212° F. and more preferably about 160° F. to about 170° F.) rinse.

In one embodiment, following the cooling step, the food pieces are cooked in a native cooking step with steam or submerged in water for a time and temperature sufficient to complete the cooking, increase the degree of starch gelatinization, reduce enzymatic activity, and soften the food pieces to the point where they can be mashed. In one embodiment, the native moisture cooking step occurs with steam at a temperature of about 190° F. to 250° F. (87.8° C. to 121° C.) for 15 to 60 minutes. Any acid added to the food piece during the soaking, blanching, and/or cooling steps is substantially removed during the native moisture cooking step.

In one embodiment, low leach flakes are made. Low leach flakes are flakes that are made from food slices that are not blanched or pre-cooked and then cooled prior to cooking. Rather, low leach flakes are made by steam cooking (e.g., a native moisture cooking step) the food slices and then mashing those cooked slices. Consequently, in one embodiment, the acid is added in the steam cooking step and the flakes are made without a blanching/pre-cooking step. An optional rinse step can be used to remove acid added to the food pieces during the cooking step. However, the condensate from the native moisture cooking step may advantageously remove suitable amounts of the acid from the slices.

In an alternative embodiment, a standard-low leach hybrid treated flake, which is more cohesive than a flake made by the process depicted in FIG. 2, but less sticky than a low leach flake described in the preceding paragraph, is made by eliminating the cooling step of the flake treatment process, but adding a hot water (160° F. to 165° F.) washing step after acid blanching and before steam cooking to rinse off excess acid from the blanched slabs. Such hot water would not cool down the acid blanched slabs allowing their gelatinized starch to retrograde. Consequently, in such an embodiment, there is still leaching loss of reducing sugars because of the water contact, so it is believed that thermally processed snacks made with this type of flake would have a flavor similar to those made from a conventional flake. By using a hot water step after the acid blanching, the washing of surface acid is preserved but the loss of flake stickiness that a cooling step promotes should be reduced. Snack dough made with a flake treated in such an alternative embodiment should have more cohesiveness than a dough made from a conventional flake. Such a flake could benefit doughs where more cohesiveness at low dough moisture is desired and should reduce snack browning and perhaps acrylamide levels by having less reducing sugars present in the flakes.

Referring back to FIG. 3, in one embodiment, following the native moisture cooking step, the cooked food slices are comminuted to form a mash. Typical means for comminuting food slices include ricing, mashing, and shredding. Next, in one embodiment, acrylamide reducing agents and preferably calcium chloride up to about 0.9% by weight of the potatoes can be added to the mash.

It should be noted that the addition of too much acid after the mashing step can make the mashed potatoes difficult to mix because when acid is added to mashed potatoes, the acid will cleave the glycosidic bonds between glucose units and make the potato surface more soluble. An increased level of soluble starch can make the dough stickier and thus can make it more difficult to mix and drum dry.

The acrylamide reducing agents added to the mash can include, but are not limited to, enzymes such as asparaginase, one or more acrylamide reducing amino acids, divalent or trivalent cations that reduce acrylamide, preferably said salts with anion that has a pKa of less than about 4, an acid and combinations thereof. In one embodiment, the acrylamide reducing agent comprises a calcium salt, and in particular, calcium chloride. The acrylamide reducing amino acids can be selected from cysteine, lysine, glycine, histidine, alanine, methionine, glutamic acid, aspartic acid, proline, phenylalanine, valine, arginine, and mixtures thereof. The salts with anion that has a pKa less than about 4 can be selected from calcium chloride, calcium lactate, calcium malate, calcium gluconate, calcium phosphate monobasic, calcium acetate, calcium lactobionate, calcium propionate, calcium stearoyl lactate, magnesium chloride, magnesium citrate, magnesium lactate, magnesium malate, magnesium gluconate, magnesium phosphate, magnesium sulfate, aluminum chloride hexahydrate, aluminum chloride, ammonium alum, potassium alum, sodium alum, aluminum sulfate, ferric chloride, ferrous gluconate, ferrous fumarate, ferrous lactate, ferrous sulfate, cupric chloride, cupric gluconate, cupric sulfate, zinc gluconate, and zinc sulfate.

Following the additive step, a drying step is performed on the mash, typically with a drum dryer. The drum dryer dries the mash into a sheet having a moisture content of about 6% to about 15%. The drum dryer does not use hot oil for drying. Following drying, the sheet can be comminuted into flakes using a comminuting apparatus such as a hammermill.

While the embodiment described above and shown in FIG. 3 can be directed towards a potato substrate, the invention can be used to make food ingredient powders, flakes, and granules from other food substrates or other food substrate combinations by the same or similar process as described above so long as the food substrate has a similar solids content and/or an acceptable reducing sugar concentration. As used herein an “acceptable reducing sugar concentration” is a reducing sugar concentration of less than about 1.5% by weight of a raw food substrate or raw food substrate combination. As used herein, a food substrate combination comprises two or more raw foods.

Consequently, in one embodiment, a raw food substrate or a raw food substrate combination having a native moisture content of up to about 89% by weight can be used in the embodiments suggested by FIG. 3 and its related discussion above. In one embodiment, raw foods having a native reducing sugar content of less than 1.5% by weight of the raw food can be used in the embodiments suggested by FIG. 3 and its related discussion above. Examples of such raw foods, by illustration and not by limitation, include carrots and peas.

In one embodiment, a food substrate combination is necessary to make a dryable food mixture. As used herein, a “dryable food mixture” is a food substrate or food substrate combination that has an acceptable reducing sugar concentration. For example, sweet potatoes have a reducing sugar concentration of greater than 1.5% by weight. Consequently, a sweet potato is an example of a single food substrate that fails to have an acceptable reducing sugar concentration, and is therefore not dryable according to the process described above.

To provide an example of how a food substrate combination can be used to make a treated dryable food mixture that can be dried into a treated dehydrated food ingredient, Applicants offer the following prophetic hybrid potato flake example. However, this example is provided for purposes of illustration and not limitation. Those having ordinary skill in the art, armed with this disclosure, will recognize that any suitable food substrate combination can be used in accordance with the teachings of the present invention.

In accordance with one embodiment of the present invention, sweet potatoes can be mixed with Russet or other suitable potato variety to lower the average reducing sugar concentration of the resulting food substrate combination to make a dryable food mixture. Other suitable potato varieties are those having reducing sugar concentrations similar to Russet such that an admix with sweet potatoes results in a dryable food mixture having less than 1.5% reducing sugars concentration, and up to 89% native moisture. In such embodiment, a dried food product comprising a hybrid potato flake can be made from such dryable food mixture. As used herein, the term “hybrid potato flake” refers to a potato flake that comprises a mixture of sweet potato content and non-sweet potato (a potato with a reducing sugar concentration below 1.5%), such as Russet potato, (hereinafter “white potato”) content. It should be noted that the term “hybrid potato flake” does not refer to a mixture of sweet potato flakes and white potato flakes. As described more fully herein below, a mixture of sweet potato flakes or granules and white potato flakes or granules will not accomplish the goals of the present invention. In the hybrid potato flake used with the present invention, each individual hybrid potato flake is partially sweet potato and partially white potato.

Hybrid potato flakes are made as follows: First, white potatoes and sweet potatoes are washed, segmented, blanched, cooled, and cooked as described above. The white potatoes and sweet potatoes are treated in an acidic solution having a pH of 3.5 and 6.0 during the blanching step, and/or cooling step. Each type of potato can be cooked in a native cooking step together or separately depending on convenience and manufacturing considerations. In some embodiments, cooking the potatoes separately allows for the use of more varieties of potatoes that cook at different rates. The primary cooking method used with the present invention is submerging the potatoes in a hot water bath for a predetermined period of time. However, other methods known in the art can be used, such as heating by condensing steam, microwave, or hot air oven. Once the potatoes are cooked, they are mixed together and mashed together to create a hybrid potato mash. Optional ingredients can also be included in the treated hybrid potato mash.

Next, the hybrid potato mash is spread in a thin layer onto a heated drum and dried. After it is dried, the moisture content of the dried sheet, and the flakes generated therefrom, have a moisture content between about 5% and about 10% by weight, or preferably between about 5% and about 7% by weight. The thin sheet of dried mash on the drum is then broken and ground, or comminuted, into hybrid flakes.

Because the hybrid potato mash is a mixture of white potatoes and sweet potatoes, each individual hybrid flake generated from the dried hybrid potato mash is also a mixture of white potato content and sweet potato content. In one embodiment, the treated hybrid potato mash comprises between about 30% and about 80% sweet potato and between about 20% and about 70% white potato by weight. Each resulting flake, therefore, has an average composition approximately equivalent to the composition of the treated mash. Thus, a flake produced from an 80/20 sweet potato/white potato hybrid mash will, on average, contain approximately 80% sweet potato and about 20% white potato.

This method of making hybrid potato flakes overcomes the difficulties encountered in producing desirable flakes from foods having relatively high levels of reducing sugars such as pure sweet potatoes. For example, unlike the treated hybrid mash described above, a 100% sweet potato mash cannot be spread onto a drum and dried because the pure sweet potato mash easily burns and discolors as it dries on the drum. A pure sweet potato mash also sticks to the drum during processing and requires more frequent cleaning of the drum during production, which is inefficient. Furthermore, if other methods are used whereby pure sweet potatoes are cooked, dried and comminuted, the resulting sweet potato product is not a desirable light flaky substance that can be used as a major ingredient in fabricated snack chips. Instead, cooked, dried and comminuted sweet potatoes generally form hard, dense granules. Snack chip dough that includes significant portions of these hard dense sweet potato granules will not effectively sheet and will not produce a snack chip that has the desirable light crispy texture of a white potato chip, but instead will have a very firm texture, even when the sweet potato granules are mixed with white potato flakes. The same result occurs when the granules are ground down into a fine flour-like substance.

As alluded to above, the sweet potato/white potato embodiment is just one example of a dryable mixture that can be made from two or more substrates. Other hybrid mashes can also be produced by cooking other food substrates and food substrate combinations, mashing them with cooked white potatoes and/or other food substrate combinations that are suitably drum dried into flakes, and using the treated hybrid mash to create a treated dehydrated food ingredient. If a high reducing sugar (above 1.5%) food substrate is mixed with a low reducing sugar (below 1.5%) white potato to form a mash, drum dried, and comminuted, the resulting flake is referred to herein as a hybrid potato flake. Moreover, a hybrid potato flake is one embodiment of a hybrid food flake, which is made from a mixture of at least one high reducing sugar (above 1.5%) food substrate mixed with at least one low reducing sugar (below 1.5%) food substrate to produce a mash with a reducing sugar concentration below about 1.5% and drum dried, to produce the hybrid food flake. One embodiment of the present invention is a food product comprising at least one hybrid food flake, wherein each said hybrid food flake comprises a first food substrate having a native reducing sugar concentration of greater than about 1.5% by weight and at a second food substrate having a native reducing sugar concentration of less than about 1.5% by weight. Another embodiment of the present invention is a hybrid food flake comprising a first food substrate having a native reducing sugar concentration of greater than about 1.5% by weight and at a second food substrate having a native reducing sugar concentration of less than about 1.5% by weight.

FIG. 4 depicts a flow diagram of a method for making dehydrated food ingredients in accordance with one embodiment of the present invention. FIG. 4 shows only one embodiment of the current invention. Various steps and ingredients may be inserted or removed from the illustrated embodiment and still be within the scope of the present invention. In one embodiment, the process of the present invention depicted in FIG. 4 can be used to make a dehydrated food ingredient from any food substrate or food substrate combination not classified as a high acid food. As used herein, a high acid food is defined as a food having a native pH of 4.6 or lower. As used herein, a low acid food is a food having a native pH of 4.7 or higher. As used herein, the native pH is the pH of a raw food without any additives.

Table 1 below shows the native pH of various different foods that can be used in accordance with various embodiments of the present invention. It should be noted that some foods have a range of pH that may be due to different varieties, growing conditions, etc. of the food substrate. If a food ingredient, such as asparagus or tomato, has a pH that spans the range of a low acid food and a high acid food, then when such ingredients are used in the present invention, the low acid variety should be used.

TABLE 1
Moisture and sugar data taken from USDA National Nutrient Database for Standard
Reference, available at: http://www.nal.usda.gov/fnic/foodcomp/search/index.html

| | | % Total sugars by | |
|---|---|---|---|
| | % Moisture | weight | |
| Raw Food | (by weight) | (wet basis) | pH* |
| Asparagus | 93.2% | 1.9% (total) | 4.0-6.0 |
| | | 0.2% sucrose | |
| Beans (Lima Beans) (immature seeds, | 70.2% | 1.48% (total) | 6.5 |
| raw) | | | |
| Beans (Kidney Beans) (mature | 90.7% | Not Available | 5.4-6.0 |
| seeds, sprouted, raw) | | | |
| Beans (Navy, mature seeds, sprouted, | 79.2% | Not Available | Not |
| raw) | | | Available** |
| Beets | 87.6% | 6.76% (total) | 4.9-5.6 |
| Broccoli (raw) | 89.3% | 1.7% (total) | Not |
| | | 0.1% (sucrose) | available |
| Cabbage | 92.2% | 3.2% (total) | 5.2-6.9 |
| | | 0.1% sucrose | |
| Carrots | 88.2% | 4.7% (total) | 4.9-5.2 |
| | | 3.6% (sucrose) | |
| Cauliflower (raw) | 92.1% | 1.9% (total) | 5.6 |
| | | 0% (sucrose) | |
| Celery (raw) | 95.4% | 1.8% (total) | 5.7-6.0 |
| | | (0.1% sucrose) | |
| Chives | 90.7% | 1.9% (total) | 5.2-6.1 |
| Corn, yellow | 10.4% | 0.6% (total) | 6.0-7.5 |
| Cucumber, peeled, raw | 96.7% | 1.4% (total) | 5.1-5.7 |
| | | 0% sucrose | |
| Lentils (raw) | 10.4% | 2.0% (total) | 6.3-6.8 |
| | | 1.5% sucrose | (cooked) |
| Mushroom (white, raw) | 92.5% | 2% (total) | 6.2 (cooked) |
| | | 0% (sucrose) | |
| Oats | 8.2% | Not Available | Not |
| | | | Available |
| Onion | 89% | 4.2% (total) | 5.3-5.8 |
| | | (0.99% sucrose) | |
| Parsley (raw) | 87.7% | 0.85% (total) | 5.7-6.0 |
| Peanuts (all types, raw) | 6.5% | 4.0% (total) | Not |
| | | | Available |
| Peas | 78.9% | 5.7% (total) | 5.8-7.0 |
| | | 5.0% sucrose | |
| Peppers (jalapeno, raw) | 91.7% | 3.5% (total) | Not |
| | | | Available |
| Peppers (sweet, green, raw) | 93.9% | 2.4% (total) | Not |
| (also known as a Green Bell | | (0.1% sucrose) | Available |
| pepper) | | | |
| Peppers, sweet, red, raw (also | 92.2% | 4.2% (total) | Not |
| known as a Red Bell Pepper) | | (0% sucrose) | Available |
| Potatoes, russet flesh and skin | 78.5% | 0.62% (total) | 5.3-6.1 |
| raw | | 0.13% (sucrose) | |
| Pumpkin (raw) | 91.6% | 1.4% (total) | 4.8-5.2 |
| Pumpkin (canned, without salt) | 90.0% | 3.3% (total) | Not |
| | | | Available |
| Radish (raw) | 95.3% | 1.86% (total) | 5.8-6.5 |
| | | 0.1% (sucrose) | |
| Squash, summer, zucchini, | 94.8% | 2.5% (total) | 5.5-6.2 |
| includes skin, raw | | 0.05% sucrose | |
| Spinach | 91.4% | 0.42% (total) | 5.5-6.8 |
| | | 0.07% sucrose | |
| Sweet Potato | 77.2% | 4.2% (total) | 5.3-5.6 |
| | | 2.5% sucrose | |
| Tofu, raw, regular, prepared | 84.5% | Not Available | Not |
| with calcium sulfate | | | Available |
| Tomato (red, ripe, raw, year- | 94.5% | 2.6% (total) | 4.2-4.9 |
| round average) | | (0% sucrose) | |
| Whey (sweet fluid) | 93.1% | 5.1% (total) | Not |
| | | | Available |

*pH data taken from http://www.fda.gov/Food/FoodSafety/FoodborneIllness/FoodborneIllnessFoodbornePathogensNaturalToxins/BadBugBook/ucm122561.htm
**“Not Available” indicates the data was not available in the source cited, however, one having ordinary skill in the art would be able to ascertain such values from the literature and/or appropriate testing without undue experimentation.

In one embodiment of the present invention, a treated food ingredient is made from a food having a relatively high native moisture content. As used herein, a high native moisture content is defined as a food having a native moisture content of greater than about 90% by weight. Examples of such foods, as indicated by Table 1 above, include but are not limited to cabbage, celery, cucumber, mushroom, peppers, pumpkin, squash, spinach, tomato, and zucchini.

Referring to FIG. 4, one or more raw foods can be washed by methods well known in the art. Next, the raw food can optionally be peeled. The peeling step discussed herein should be construed to include removal of any undesirable portion of the food substrate. For example, if carrots are used in the embodiment shown in FIG. 3, the root and the stem can both be removed from the taproot. Similarly, in the embodiment shown in FIG. 4, the root and stem from a radish and/or the ends of an onion can be removed and the stem of a tomato or pumpkin can be removed.

The washed and optionally peeled food can optionally be segmented into smaller size pieces. For example, segmentation may not be necessary if peas are being used. Depending on the type of food substrate used, additional processing may be required. For example, if pumpkin is being used, it may be desirable to remove the seeds before or after segmenting the pumpkin into smaller pieces. Segmenting can comprise slicing, dicing, ricing, cubing, etc. Virtually any method which reduces the size of the food can be used in the segmenting step.

In one embodiment, two or more segmented or whole, peeled or unpeeled, raw foods are blended together to reach a desired composition. For example, bell pepper pieces can be mixed with pumpkin pieces, squash and mushrooms. In one embodiment, different raw foods are blended together prior to blanching to make a dryable mixture.

In one embodiment, the segmented or whole blended or unblended pieces are then dry or wet blanched at a temperature of between about 160° F. and about 180° F. and most preferably between about 160° F. and about 175° F. In one embodiment, the food pieces are blanched for a time and temperature sufficient to deactivate undesirable enzymes as known in the art. In one embodiment, the food pieces are blanched for between about between about 15 minutes and about 30 minutes.

In one embodiment the blanched food pieces are optionally cooled to remove free starch from the surface and retrograde gelatinized starch. In one embodiment, the blanched food pieces are cooled for between about 10 minutes and about 60 minutes at a temperature of between about 48° F. (8.9° C.) and about 60° F. (15.6° C.).

The blanched food pieces can then be optionally ground to make a dryable food mixture. In one embodiment, the dryable food mixture comprises a puree. As used herein, a puree is a natural food product such as a fruit or vegetable that has been ground, pressed, or strained to the consistency of a soft paste or thick liquid (similar to a mash) that has substantially the same percentage of solids by weight as the original unprocessed raw food.

In one embodiment, an acid is added just prior to blanching, during blanching or after blanching, but before the mixture is ground into a mash or puree. If the acid is added prior to or during blanching, then the amount of acid should be sufficient such that the food pieces are contacted in an acidic solution having a pH of between about 3.0 and about 6.0 and in one embodiment between about 3.5 and about 5.0 in the blancher. If acid is added subsequent to the blanching step, then sufficient acid should be added such that the pH of the puree is between about 3.0 and 6.0.

In one embodiment, the acid used can be selected from acids recognized both as food grade and Generally Recognized as Safe (GRAS) by the Food Chemical News Guide. It should be pointed out that food grade acids can be a strong acid, a weak acid, or an organic acid, and mixtures thereof. Examples of food grade acids include, but are not limited to, one or more acids selected from citric acid, phosphoric acid, and hydrochloric acid.

Following the acid addition step, a drying step is performed on the dryable food mixture comprising a puree. In one embodiment, the same type of drum dryer used to dehydrate potato flakes can be used. The drum dryer uses steam to dry the puree into a food sheet having a moisture content of about 6% to about 15%. Other suitable dryers can be used including, but not limited to fluidized bed dryers.

As in the embodiments discussed in relation to FIG. 3, in embodiments depicted in FIG. 4, food substrate or food substrate combinations having reducing sugar concentrations above the acceptable reducing sugar concentration are mixed with a sufficient amount of a food having a lower reducing sugar concentration, e.g., white potato mash, such that the puree mixture comprises a dryable mixture. In one embodiment, dry ingredients such as treated potato flakes and/or tapioca starch can be added to the puree so that a non-stick food sheet can be made on the drum dryer.

Table 1 depicts total sugar contents and sucrose contents of various food substrates. The reducing sugar concentration is the total sugar concentration minus the sucrose concentration. Carrots are shown as having a total sugar concentration of 4.7% by weight of the carrot and 3.6% of that total is sucrose. Consequently, carrots have a reducing sugar concentration of about 0.9% by weight on a wet basis. If no value is noted for sucrose, total sugars, and/or moisture content, the USDA Table did not provide the information.

In one embodiment, acrylamide reducing agents are added to the puree during or after blanching. Such additives can include, but are not limited to, enzymes such as asparaginase, one or more acrylamide reducing amino acids, divalent or trivalent cations that reduce acrylamide, preferably said salts with anion that has a pKa of less than about 4, an acid and combinations thereof. In one embodiment, the acrylamide reducing agent comprises a calcium salt. The acrylamide reducing amino acids can be selected from cysteine, lysine, glycine, histidine, alanine, methionine, glutamic acid, aspartic acid, proline, phenylalanine, valine, arginine, and mixtures thereof. The salts with anion that has a pKa less than about 4 can be selected from calcium chloride, calcium lactate, calcium malate, calcium gluconate, calcium phosphate monobasic, calcium acetate, calcium lactobionate, calcium propionate, calcium stearoyl lactate, magnesium chloride, magnesium citrate, magnesium lactate, magnesium malate, magnesium gluconate, magnesium phosphate, magnesium sulfate, aluminum chloride hexahydrate, aluminum chloride, ammonium alum, potassium alum, sodium alum, aluminum sulfate, ferric chloride, ferrous gluconate, ferrous fumarate, ferrous lactate, ferrous sulfate, cupric chloride, cupric gluconate, cupric sulfate, zinc gluconate, and zinc sulfate.

Next, in one embodiment, the dryable mixture comprising a puree is spread in a thin layer onto a heated drum and dried. After it is dried, the moisture content of the dried sheet, and the treated dehydrated food ingredient generated therefrom, has a moisture content between about 5% and 16% by weight, or preferably between about 5% and about 7% by weight. In one embodiment, the thin sheet of dried mash on the drum is then broken and ground, or comminuted, into a treated dehydrated food flake. If a mixture of food substrates is used, the comminuted product is a hybrid food flake.

In one embodiment the particle size distribution of the treated dehydrated food ingredient is as follows: between about 40% and about 50% sit on a #40 U.S. mesh screen; between about 25% and about 35% sit on a #60 U.S. mesh screen; between about 5% and about 15% sit on a #80 U.S. mesh screen; between about 3% and about 8% sit on a #100 U.S. mesh screen; and less than about 10% pass through a #100 U.S. mesh screen. All mesh screen sizes are based on the U.S. Sieve Scale and the opening size for each Mesh Screen is summarized in the following table:

TABLE 2
U.S. Sieve # Opening Sizes

Opening Size

| U.S. Sieve # | Millimeters | Inches |
|---|---|---|
| 20 | 0.853 | 0.0336 |
| 40 | 0.420 | 0.0165 |
| 60 | 0.250 | 0.0098 |
| 80 | 0.177 | 0.0070 |
| 100 | 0.149 | 0.0059 |

The applicants herein have found that mixing cooked or uncooked food products to create a dryable mixture, which is then dried and comminuted, produces a treated dehydrated food ingredient. This treated dehydrated food ingredient is superior to the prior art dehydrated food ingredients because, for example, when used as an ingredient in a hydrated dough, and the resulting dough is used to produce a fabricated snack chip, the final snack chip has a reduced level of acrylamide. Of course, those having ordinary skill in the art, armed with this disclosure, will recognize that the treated dehydrated food ingredient can be used as ingredient in many food products that are eventually thermally processed, including, but not limited to those foods discussed below.

In one embodiment, the method of making a treated dehydrated food ingredient (or flake) from a dryable mixture comprising a puree overcomes the difficulties encountered in producing desirable dehydrated food ingredients from a wider variety of food substrates having high moisture such as pumpkin or high reducing sugars such as sweet potato, or food substrates having both high moisture and high reducing sugars such as red and green peppers.

Such treated dehydrated food ingredient can be used as a food ingredient in a dough to make fabricated food products having a reduced level of acrylamide as compared to untreated (e.g., no acid treatment) dehydrated food ingredients. The term “fabricated food” means a food that uses as its starting ingredient something other than the original and unaltered starchy starting material. For example, fabricated snacks include fabricated potato chips that use a dehydrated potato product as a starting material and corn chips that use masa flour as its starting material. By way of example only, and without limitation, examples of “fabricated foods” which treated dehydrated food ingredient can be used as an ingredient in making the dough include multigrain chips, crackers, breads (such as rye, wheat, oat, potato, white, whole grain, and mixed flours), soft and hard pretzels, pastries, cookies, toast, corn tortillas, flour tortillas, pita bread, croissants, pie crusts, muffins, brownies, cakes, bagels, doughnuts, cereals, extruded snacks, granola products, flours, corn meal, masa, potato flakes, polenta, batter mixes and dough products, refrigerated and frozen doughs, reconstituted foods, processed and frozen foods, breading on meats and vegetables, hash browns, mashed potatoes, crepes, pancakes, waffles, pizza crust, peanut butter, foods containing chopped and processed nuts, jellies, fillings, mashed fruits, mashed vegetables, cocoa, cocoa powder, chocolate, hot chocolate, cheese, animal foods such as dog and cat kibble, and any other human or animal food products that are subject to sheeting or extruding or that are made from a dough or mixture of ingredients.

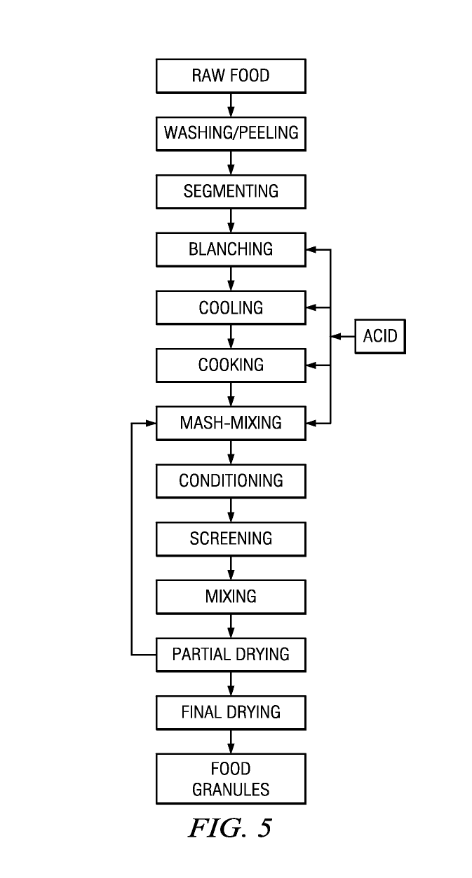

FIG. 5 depicts a flow diagram of a method for making treated food flakes in accordance with one embodiment of the present invention. While numerous food substrates and food substrate combinations having an acceptable reducing sugar concentration can be made into treated flakes, the following example related to potatoes is provided for purposes of illustration and not limitation. First, a ratio of white potatoes and sweet potatoes are washed, segmented, blanched, cooled, and cooked as described above. The ratio is selected so as to comprise a dryable food mixture. The white potatoes and sweet potatoes are treated in an acidic solution having a pH of 3.5 and 6.0 during the blanching step, the cooling step, the cooking step, the mash mixing step, or any combination thereof. Each type of potato can be cooked together or separately depending on convenience and manufacturing considerations. In some embodiments, cooking the potatoes separately allows for the use of more varieties of potatoes that cook at different rates. The primary cooking method used with the present invention is submerging the potatoes in a hot water/steam bath (e.g., 190° F. to 250° F.) for a predetermined period of time. However, other methods known in the art can be used, such as heating by condensing steam, microwave, or hot air oven. Once the potatoes are cooked, they are mixed together and mashed together to create a dryable food mixture comprising a hybrid potato mash. During a mash mixing step, hot hybrid potato mash is mixed with dry add-back flakes until a homogeneous moist mix is obtained. Following mash mixing, a conditioning step equalizes the moisture throughout the mix, which is then passed over a fine mesh vibrating screen to remove large agglomerates and bruised portions of potato tissues. The product is then further mixed, and dried using a drying apparatus such as an air lift dryer, or a fluidized bed dryer. Following partial drying to a moisture content of about 12% to about 13%, a portion of the material is removed for add back, and the remainder is then finish dried to a moisture content of about 6% to about 10%, again by using a drying apparatus to make a treated dehydrated potato flakes. While the above process has been shown with a potato substrate example, a dehydrated food ingredient can be made from other food substrates in accordance with various embodiments of the present invention.

In one embodiment, the present invention can be used to treat dehydrofrozen food product. For example, in one embodiment, dehydrofrozen potatoes are made by cutting raw potatoes into cubes. Any suitable cube size can be used including a cube having dimensions of ¼-inch or ⅜-inch on each side to cubes having sizes of ½″×1″×1″. The cubes can then be acid blanched in a solution having a pH of between about 3.5 and about 6.0 at a temperature of between about 150° F. to about 180° F. and then partially dried in an oven to a moisture content of between about 10% and about 65% and more preferably between about 52% to about 62% by weight. The partially dried cubes can then be frozen for later use. In one embodiment, the dried cubes can be ground or comminuted as desired prior to freezing.

### EXAMPLES

The following examples are provided to more fully illustrate the invention and are not intended to be limitative thereof.

### Example 1

### Comparative Tests of Acid Treated Slabs v. Acid Treated Mash

To ascertain the impact of various treatments of potato while making potato flakes, a control sample was compared with five other samples of potato flakes made in accordance with various embodiments of the present invention.

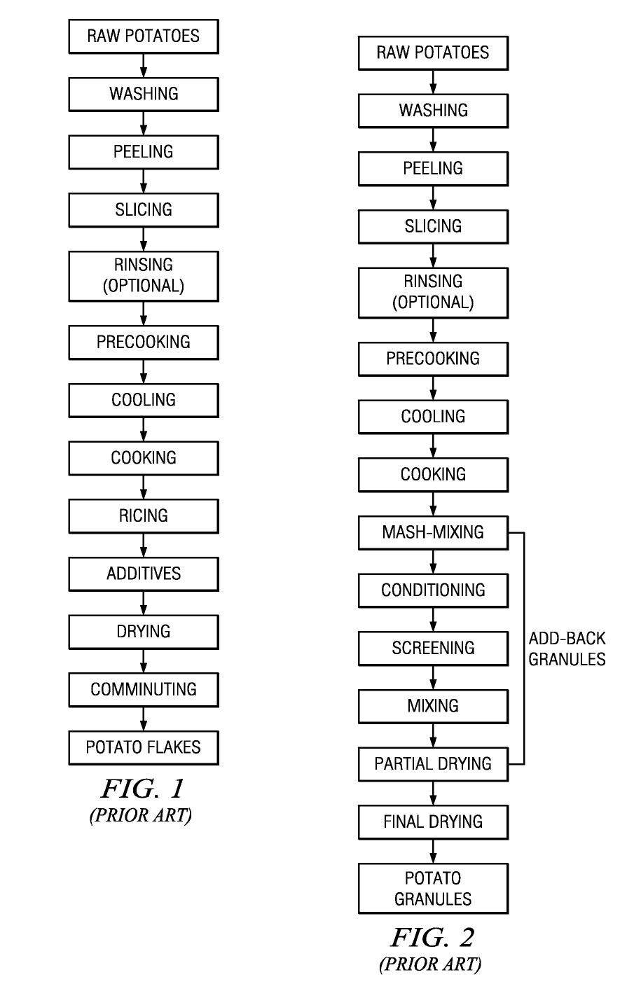

A series of tests were designed to evaluate the relative effectiveness of various treatments to potato slices in making treated flakes that would be used to make low acrylamide fried or baked products. The control flakes were made by a prior art process similar to that discussed in FIG. 1, without the use of any added acid or calcium chloride. The test flakes were made from sliced potatoes that were placed into various solutions for treatment for 15 minutes. For example, in Tests 1-3 and 5 shown in the Table immediately below, different amounts of additives were added to the mash after the mashing step shown in FIG. 3. The amount of additive acid added to the mash was based on the weight percent of potatoes in the mash/blancher. In Tests 4 and 5, acid was added to the potato slabs during the blanching step shown in FIG. 3. The potato slabs were acid blanched at about 160° F. for about 15 minutes. The potato flakes were drum dried to a moisture content of about 7.5% to about 11%.

The flakes from each flake sample were mixed with pre-gelled starch, sugar, chemical leavening agents, lecithin, oil, and water to make a potato crisp dough. Potato flakes were about 80% of the dough ingredients (i.e., without added water). The dough was sheeted and cut into chip shapes and baked to less than about 2% moisture by weight in an oven having a temperature profile starting at about 550° F. and ending at about 270° F. The baked potato crisps were tested for acrylamide by GC-MS. The baked potato crisps were then tasted by an expert laboratory panel. The results of the tests are shown below.

TABLE 3
Batch Test

| | | Amount | | AA, % | |
|---|---|---|---|---|---|
| Test | Treatment** | (wt %)* | Treatment | Reduction** | Comment**** |
| 1 | Phosphoric Acid | 0.05% | Mash | 1.83% | Off Flavor |
| 2 | Phosphoric Acid | 0.09% | Mash | 59.47% | Off Flavor |
| 3 | Phosphoric Acid + CaCl₂ | 0.09% & | Mash | 89.24% | Off Flavor |
| | | 0.18% | | | |
| 4 | Hydrochloric Acid | 0.13% | Slab | 50.71% | No Off Flavors |
| 5 | Hydrochloric Acid + | 0.25% & | Slab & | 93.76% | No Off Flavors |
| | CaCl₂*** | 0.10% | Mash | | |

*Based on 200 lb potatoes with 30 gal water during blanching
**For Baked Product - Compared with control sample made at same time.
***Acid in Blancher and CaCl₂ in Mash
****Finish Product Evaluation by Lab Expert Panel

These tests demonstrate that treatment of potato slabs in acid prior to the cooking step when making potato flakes can effectively make low acrylamide flakes, with less calcium chloride addition to the mash with no resultant off-flavors. It is believed that the lack of off-flavors is a consequence of the fact that any acid added during the blanching step is washed off during the cooling and native moisture cooking steps as a result of the contact with the cooling water, steam, condensate, and/or hot water. The addition of acid to the mash, on the other hand, is not removed prior to drum drying, carries over to the baked crisps, and therefore results in off-flavors. Further, because acid is mixed into the mash, the removal of such acid would very difficult.

### Example 2

### Tests of Calcium Chloride Treated Slabs

Another test was conducted to analyze the effects of calcium chloride addition at the blanching step. The control batch did not add calcium chloride to any of the processing steps during the manufacture of the potato flakes. A batch of potato flakes was made where 0.92% calcium chloride by weight of raw potatoes was added to the potato slabs in the blanching step, shown in FIG. 3.

The flakes from each flake sample were mixed with pre-gelled starch, sugar, chemical leavening agents, lecithin, oil, and water to make a potato crisp dough. Potato flakes were about 80% of the dough ingredients (i.e., without added water). The dough was sheeted and cut into chip shapes and baked to less than 2% moisture by weight in an oven having a temperature profile starting at about 550° F. and ending at about 270° F. The baked potato crisps were tested for acrylamide by GC-MS. The baked potato crisps were then tasted by an expert laboratory panel. The results of the test are shown below.

TABLE 4
Batch Test - 50 lb potatoes/hr

| | | | AA, % | |
|---|---|---|---|---|
| Treatment | Amount | Treatment | Reduction* | Comment*** |
| Calcium Chloride | 0.92% | Slab | 0.00% | No Off Flavors |

***Finish Product Evaluation by Lab Expert Panel

As revealed by the test above, the addition of calcium chloride at the blanching step, unlike acid, has no effect on the acrylamide level of the food product made from the flakes.

### Example 3

### Acid Treatment of Potato Flakes During Blanching

Based on the test results above, a series of further tests was designed to evaluate the relative effectiveness of various potato slab treatments for making low acrylamide flakes and to compare the taste and texture aspects of finished product made from control flakes and the treated flakes or low acrylamide flakes. Specifically, additional testing was conducted with acidic treatments at the blancher.

To ascertain the impact of various treatments of potato while making potato flakes, a control sample was compared with twelve other samples of potato flakes made in accordance with various embodiments of the present invention.

The control flakes were made by a prior art process similar to that discussed in FIG. 1, without the use of any added acid or calcium chloride. The test flakes were made from potato slabs that were placed into various solutions of food grade hydrochloric acid for treatment for 15 minutes.

The flakes from each flake sample were mixed with pre-gelled starch, sugar, chemical leavening agents, lecithin, oil, and water to make a potato crisp dough. Potato flakes were about 80% of the dough ingredients on a dry basis (i.e., without added water). The dough was sheeted and cut into chip shapes and baked to less than 2% moisture by weight in an oven having a temperature profile starting at about 550° F. and ending at about 270° F. The baked potato crisps were tested for acrylamide by GC-MS. The baked potato crisps were then tasted by an expert laboratory panel.

The attributes of acceptability were rated on a nine point Likert scale. A response of nine indicates that a consumer liked the particular quality being evaluated extremely; a response of eight indicates that the consumer liked the quality being evaluated very much; seven indicates the consumer liked it moderately; six indicates the consumer liked the quality slightly; five indicates that the consumer neither liked nor disliked the quality; four indicates that the consumer disliked the quality slightly; three indicates that the consumer disliked if moderately; two indicates that the consumer disliked it very much; and one indicates that the consumer disliked the quality being evaluated extremely. The results of the tests are shown below.

TABLE 5

| Scaled Line-Continuous Process-24000 lb potatoes/hr | | | | | | | | |
|---|---|---|---|---|---|---|---|---|
| | Treated | | | | | | | |
| | Flake | Baked | % AA | | | GC-MS Analysis-Finish Product | | |
| | Reducing | Snack | Reduction | Overall | | | | Phenyl- |
| | Sugar | Moisture, | Baked | Consumer | Flavor | Methional | DEP * 100¹ | acetaldehyde, |
| Treatment | % | % | Snack | Acceptability | Acceptability | ppm² | ppm² | ppm² |
| Control-⅜ | 1.48 | 2.7 | 0% | 6.87 | 5.98 | 0.90 | 1.58 | 0.95 |
| Slab-No | | | | | | | | |
| Treatment | | | | | | | | |
| 5/16 Slab-pH 5 | 1.93 | 2.24 | 32.29% | 6.57 | 6.87 | 0.83 | 0.83 | 0.88 |
| No Ca | | | | | | | | |
| ⅜″ Slab-pH 4- | | | | | | | | |
| 0.15% CaCl₂ | 1.20 | 2.12 | 44.36% | 6.68 | 6.85 | 0.84 | 1.07 | 0.94 |
| 5/16″ Slab-pH 5- | | | | | | | | |
| 0.30% CaCl₂ | 1.87 | 1.64 | 61.08% | 6.87 | 6.68 | 0.83 | 0.59 | 0.84 |
| ⅜″ Slab-pH 5- | | | | | | | | |
| 0.15% CaCl₂ | 1.38 | 2.6 | 63.01% | 7.01 | 6.95 | 0.71 | 0.71 | 0.78 |
| 5/16″ Slab-pH 5- | | | | | | | | |
| 0.15% CaCl₂ | 1.42 | 2.24 | 65.05% | 6.17 | 5.75 | 0.75 | 0.69 | 0.65 |
| 5/16″ Slab- | | | | | | | | |
| 0.30% CaCl₂ | 2.35 | 2.62 | 68.34% | 6.4 | 6.12 | 0.71 | 0.51 | 0.66 |
| 5/16″ Slab-pH 4- | | | | | | | | |
| 0.30% CaCl₂ | 1.84 | 1.52 | 68.81% | 6.8 | 6.82 | 0.78 | 0.33 | 0.61 |
| ⅜″ Slab-pH 4- | | | | | | | | |
| 0.30% CaCl₂ | 1.23 | 2.36 | 72.41% | 7.01 | 7.18 | 0.64 | 0.46 | 0.74 |
| 5/16″ Slab-pH 4- | | | | | | | | |
| 0.15% CaCl₂ | 2.17 | 1.49 | 74.01% | 6.6 | 6.52 | 0.74 | 0.42 | 0.74 |

¹DEP * 100 is the value of the dimethyl-ethyl-pyrazine multiplied by 100
²ppm means parts of a substance per million parts of product

As revealed by the data above, the use of acid during the blanching step, followed by the addition of calcium chloride during the mashing step and prior to drum drying results in a treated potato flake that can be used to make low acrylamide fried and baked snacks. This data further supports the conclusion that treated flakes, made by the use of acid prior to the native moisture cooking step coupled with the use of calcium chloride during the mashing step, when subsequently fried to moisture contents below about 3% by weight, results in a food product that has substantially less acrylamide in the finished food product than if the acidic pretreatment did not occur and calcium chloride was not added.

As revealed by the tests above, the addition of acid prior to the native moisture cooking step and prior to the mashing step results in a treated potato flake that can be used to make low acrylamide fried and baked snacks. As used herein, the term “low acrylamide potato flakes” means potato flakes that have been acid blanched prior to or during a native moisture cooking step, but prior to a mashing step so as to produce a potato flake that, upon subsequent thermally processing at food temperatures above about 120° C. to a moisture content of less than about 3% by weight results in a food product having an acrylamide level lower than potato flakes thermally processed without the acid blanching prior to steam cooking. Further, use of the treated potato flake of the present invention as an ingredient in a low moisture food product results in a food product having a lower acrylamide concentration than if the product is made from prior art flakes made without an acid treatment step prior to the mashing step. Further, in one embodiment, because the acid treatment occurs before or during the blanching step, the acidic solutions can be washed away during subsequent cooking and other unit operations. Consequently, off-flavors from the acid are minimized and are not detectable by most consumers and the consumer acceptability data in the Table above suggests the food product made from treated flakes is close to the control food product made from untreated flakes for both overall consumer acceptability (texture, taste, flavor) and flavor acceptability.

Also revealed by the data presented in the Table above is the reduction of components associated with aspects of the Maillard browning reaction that relate to acrylamide formation. The Maillard reaction forms brown color, Strecker aldehydes (e.g., methional and phenylacetaldehye), pyrazines (e.g., dimethyl-ethyl-pyrazine), and acrylamide. Dimethyl-ethyl-pyrazine concentrations, for example have had relatively high correlations (e.g., r-squared of 0.85) with acrylamide concentrations. Acrylamide and pyrazines are well correlated because pyrazines are formed from ammonia that is released from asparagine and because the activation energy for pyrazine formation is similar to the activation energy for acrylamide formation.

The analytical data of the components associated with aspects of the Maillard browning action that relate to acrylamide formation further supports the data and trend indicating reduced levels of acrylamide in foods made from treated flakes.

### Example 4

### Comparative Acid Blanching—Phosphoric v. Hydrochloric

To compare the effect of acid blanching of a weak acid versus a strong acid, a series of further tests were conducted to evaluate the relative effectiveness of various potato slice treatments for making low acrylamide flakes and to compare the titratable acidity of the blanch water using two different acids for acid blanching.

The control flakes were made by a prior art process similar to that discussed in FIG. 1, without the use of any added acid or calcium chloride. The test flakes were made from sliced potatoes that were placed into one of two acidic solutions for acid blanching at 160° F. for 15 minutes. The pH of the blanch water was measured shortly after concentrated acid was mixed into a kettle of hot water and potato slabs. A sample of the blanch water was simultaneously taken and tested for the titratable acidity using 0.1 N NaOH. The pH and titratable acidity were each measured again at the exit of the blancher after the potato slices had been in the acid blanch for 15 minutes. The potato slabs were then cooled, and native moisture cooked followed by mashing. Calcium chloride was added to some of the test samples after the mashing step, shown in FIG. 3. The mashed potatoes were then drum dried to make potato flakes.

The flakes from each flake sample were mixed with pre-gelled starch, sugar, chemical leavening agents, lecithin, oil, and water to make a potato crisp dough. Potato flakes were about 80% of the dough ingredients on a dry basis (i.e., without added water). The dough was sheeted and cut into chip shapes and baked to less than 2% moisture by weight in an oven having a temperature profile starting at about 550° F. and ending at about 270° F. The baked potato crisps were tested for acrylamide by GC-MS. The results of the tests are shown below. Those having ordinary skill in the art will understand that H₃PO₄ corresponds to phosphoric and, CaCl₂ corresponds to calcium chloride, and HCl corresponds to hydrochloric acid.

TABLE 6
Comparative Acid Blanching

| | | | | | Blanch | | | |
|---|---|---|---|---|---|---|---|---|
| | | | | | solution | | | |
| | | | | | Titratable | | | |
| | | | Wt % | Blanch | Acidity | | Baked | |
| | | | acid per | Solution | (ml 0.1N | Wt % | Crisp | |
| | Slab | | 200 lbs | pH After | NaOH) after | CaCl₂ | Finish | AA |
| | Thickness | Acid | Potatoes + | 15 min | 15 min | per lb of | Moisture, | % |
| Description | (inches) | Type | 30 gal water | blanch | Blanch | potatoes | % | Reduction |
| Control | 0.28 | None | 0 | 6.7 | 0.20 | 0.00% | 2.19 | 0.00% |
| No Acid | | | | | | | | |
| No CaCl₂ | | | | | | | | |
| Low HCl | 0.32 | HCl | 0.01% | 5.8 | 0.8 | 0.00% | 1.69 | 12.20% |
| No CaCl₂ | | | | | | | | |
| Low H₃PO₄ | 0.30 | H₃PO₄ | 0.03% | 5.7 | 1.2 | 0.00% | 1.49 | −3.77% |
| No CaCl₂ | | | | | | | | |
| Low HCl | 0.32 | HCl | 0.01% | 5.6 | 1.0 | 0.13% | 1.67 | 71.50% |
| With CaCl₂ | | | | | | | | |
| Low H₃PO₄ | 0.29 | H₃PO₄ | 0.03% | 5.6 | 1.3 | 0.13% | 1.66 | 37.00% |
| With CaCl₂ | | | | | | | | |
| Mid HCl | 0.31 | HCl | 0.03% | 4.7 | 1.6 | 0.06% | 1.79 | 69.72% |
| With CaCl₂ | | | | | | | | |
| Mid H₃PO₄ | 0.30 | H₃PO₄ | 0.06% | 5.8 | 2.2 | 0.06% | 1.54 | 19.70% |
| With CaCl₂ | | | | | | | | |
| High HCl | 0.30 | HCl | 0.05% | 4.3 | 1.9 | 0.00% | 1.44 | 22.28% |
| No CaCl₂ | | | | | | | | |
| High H₃PO₄ | 0.28 | H₃PO₄ | 0.11% | 4 | 3 | 0.00% | 1.67 | 28.47% |
| No CaCl₂ | | | | | | | | |
| High HCl | 0.30 | HCl | 0.05% | 4.3 | 1.6 | 0.13% | 1.76 | 64.55% |
| With CaCl₂ | | | | | | | | |
| High H₃PO₄ | 0.27 | H₃PO₄ | 0.11% | 4.4 | 3.2 | 0.13% | 1.99 | 67.26% |
| With CaCl₂ | | | | | | | | |

Interestingly, in several of the tests, food products made from flakes treated with hydrochloric acid produced substantially lower or similar levels of acrylamide as food products made from flakes treated with phosphoric acid, even when the addition of the phosphoric acid created a similar pH. Consequently, the trend seems to indicate that hydrochloric acid is more effective than phosphoric acid.

While the above disclosure demonstrates the applicability of the present invention to potato flakes and foods made from potato flakes and potato granules, the present invention can be applied to other food products such as potato flour that are blanched, cut and cooked at native moisture content prior to being thermally processed. For example, canned corn is prepared by cleaning the corn to remove silk and other extraneous material, blanching the corn to deactivate enzymes, cutting the corn off the cob and placing the corn into a container, adding brine, acidified water or other suitable solution to corn, sealing the container and heating the container in a native moisture cooking step. The native moisture cooking steps can occur for various times and temperatures based on the food product at issue. For example, when retorting a canned corn, the native moisture cooking step can occur, for example, at elevated pressures (e.g., about 30 psig) and at temperatures ranging from about 240° F. to about 270° F. for at least about 5 minutes and between about 5 minutes and about 180 minutes. The can is then cooled and the treated corn can be used as an ingredient in a thermally processed food product.

While the invention has been particularly shown and described with reference to several preferred embodiments, it will be understood by those skilled in the art that various changes in form and detail may be made therein without departing from the spirit and scope of the invention.

What is claimed is:

1. A method for making a dehydrated food ingredient, said method comprising the steps of:
selecting one or more low acid raw foods that can be made into a dryable mixture;
optionally segmenting said low acid raw foods to make a plurality of food pieces, each food piece having a native moisture content;
blanching said food pieces;
optionally grinding said food pieces into a dryable mixture;
adding an acid to said one or more low acid foods to make a treated dryable mixture; and
drying said treated dryable mixture to a moisture content of between about 6% and about 15% by weight to make said dehydrated food ingredient.

2. The method of claim 1 wherein said acid is added during said blanching.

3. The method of claim 1 wherein said acid is added to said mixture during a native cooking step.

4. The method of claim 1 wherein said low acid raw food comprises a native moisture content of at least about 90% by weight.

5. The method of claim 1 wherein said dehydrated food ingredient is made without a cooking step.

6. The method of claim 1 wherein said dryable mixture comprises a reducing sugar content of less than about 1.5% by weight.

7. The method of claim 1 wherein said dryable mixture comprises a first food substrate having a native reducing sugar concentration of greater than about 1.5% by weight and at a second food substrate having a native reducing sugar concentration of less than about 1.5% by weight.

8. The method of claim 7 wherein said food substrate comprises at least one of pumpkin, tomato, onion and mushroom.

9. The method of claim 1 wherein said dehydrated food ingredient is a hybrid food flake.

10. The method of claim 1 wherein said dehydrated food ingredient is a hybrid potato flake.

11. The method of claim 1 further comprising the steps of cooking said food pieces after said blanching.

12. The method of claim 1 wherein said treated dryable mixture is frozen prior to said drying.

13. The method of claim 11 wherein said drying further comprises a partial drying step wherein said food pieces are dried to a moisture content of between about 10% and about 14% and a final drying step wherein said food pieces are dried to a moisture content of between about 6% and about 9% and wherein a portion of said treated dryable mixture after said partial drying step is routed back to said grinding step.

14. The method of claim 1 wherein said low acid raw food such that at least about 88% of the peel is removed from an outer surface area of said low acid raw food.

15. The method of claim 1 wherein an acrylamide reducing agent is added to said dryable food mixture prior to said drying step but after said acid adding step.

16. The method of claim 15 wherein said acid is substantially removed from said food prior to said acrylamide reducing agent adding step.

17. A food product comprising at least one hybrid food flake, wherein each said hybrid food flake comprises a first food substrate having a native reducing sugar concentration of greater than about 1.5% by weight and at a second food substrate having a native reducing sugar concentration of less than about 1.5% by weight.

18. A hybrid food flake comprising a first food substrate having a native reducing sugar concentration of greater than about 1.5% by weight and at a second food substrate having a native reducing sugar concentration of less than about 1.5% by weight.
